(19) United States
(12) Patent Application Publication
(10) Pub. No.: US 2023/0133685 A1
(43) Pub. Date: May 4, 2023

(54) CAMERA SYSTEMS FOR TRACKING TARGET OBJECTS

(71) Applicant: HEWLETT-PACKARD DEVELOPMENT COMPANY, L.P., Spring, TX (US)

(72) Inventors: Chih-Cheng Chang, Taipei City (TW); Chien-Hao Lu, Taipei City (TW); Po-Ju Tseng, Taipei City (TW)

(21) Appl. No.: 17/514,531

(22) Filed: Oct. 29, 2021

(51) Int. Cl. H04N 5/232; G01S 17/66; G01S 17/86

(52) U.S. Cl. CPC H04N 5/23299; G01S 17/66; G01S 17/86

(57) ABSTRACT

An example camera system for tracking a target object within a coverage area, the camera system includes: a camera having a primary field of view; a plurality of auxiliary sensors, each auxiliary sensor to generate auxiliary sensor data representing a respective auxiliary field of view of at least a portion of the coverage area; a controller to: obtain the auxiliary sensor data from each of the auxiliary sensors; and determine, based on the auxiliary sensor data, a location of the target object within the coverage area; and a motor connected to the camera to rotate the camera to locate the target object within the primary field of view.

### BACKGROUND

Camera systems may be used in conjunction with computing devices for a variety of applications, such as video conferencing, online presentations, and the like.

### BRIEF DESCRIPTION OF THE DRAWINGS

FIG. 1 is a schematic diagram of an example camera system for tracking target objects.

FIG. 2 is a schematic diagram of an example camera mount for tracking target objects.

FIG. 3 is a flowchart of an example method of tracking target objects in a camera system.

FIG. 4 is a flowchart of an example method of determining a location of the target object at block 304 of the method of FIG. 3.

FIGS. 5A and 5B are schematic diagrams of the performance of blocks 412 and 414 of the method of FIG. 4, respectively.

FIG. 6 is a schematic diagram of another example camera system for tracking target objects.

FIG. 7 is a flowchart of an example method of determining a location and rotating the camera at blocks 304 and 306 of the method of FIG. 3.

FIG. 8 is a schematic diagram of the example camera system of FIG. 1 including a vertical auxiliary sensor.

FIG. 9 is a flowchart of an example method of changing a pitch of the camera in the system of FIG. 8.

### DETAILED DESCRIPTION

In certain applications of video conferencing, it may be useful for the camera system to be able to identify a target object and rotate its field of view to track the location of the target object to maintain the target object within its field of view. For example, computing devices may employ image processing and artificial intelligence to analyze the video or image data, identify the target object, and track its location. However, such solutions are computationally expensive.

An example camera system for tracking target objects may use inexpensive auxiliary sensors, such as time-of-flight sensors to track target objects based on sensor data, rather than employing image processing or artificial intelligence techniques to reduce the computational load of tracking the target object. In some examples, the camera system includes auxiliary sensors, such as time-of-flight sensors, which scan a portion of a coverage area for the camera system. A controller uses the auxiliary sensor data from the auxiliary sensors to determine the location of a target object. For example, the auxiliary sensors may each cover a sector of the coverage area, and the controller may identify sectors of the coverage area having an object in them based on whether the corresponding auxiliary sensor detects an object. The controller may then identify the closest or furthest object as the target object, and select the corresponding sector as containing the target object. The controller may then control a motor to rotate the camera to locate the target object within the field of view of the camera. That is, the motor rotates the camera such that the field of view of the camera overlaps with the sector identified as containing the target object.

In other examples, two auxiliary sensors may be laterally spaced from the camera, and have respective fields of view which overlap within the field of view of the camera. Accordingly, the controller may control the motor to rotate the camera until the target object is detected by both auxiliary sensors (i.e., the target object is in the overlapping portion, and hence in the field of view of the camera. The direction of rotation may be determined based on which auxiliary sensor detects the target object. The camera system may be a stand-alone camera system, or may be integrated into an all-in-one device or the like. Alternately, the sensors and controller may be implemented in a camera mount which receives a camera.

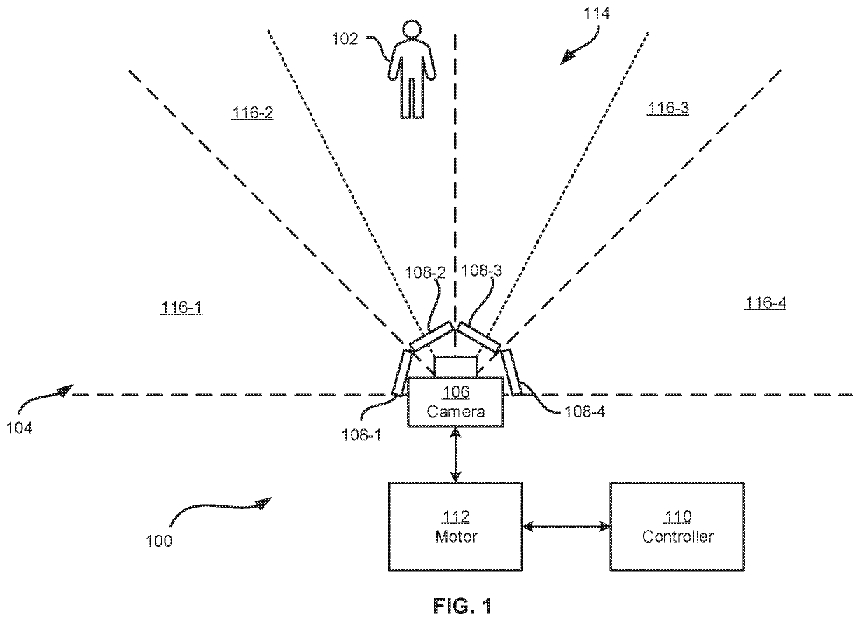

FIG. 1 shows a schematic diagram of an example camera system 100 for tracking a target object 102 within a coverage area 104 for the camera system 100. The camera system 100 includes a camera 106, a plurality of auxiliary sensors, of which four example auxiliary sensors 108-1, 108-2, 108-3, 108-4 are depicted, a controller 110, and a motor 112. The camera system 100 may be used to track a user, such as a teacher teaching a class, as the target object 102, to allow the teacher to freely move back and forth within a classroom while remaining in frame of the camera 106. For example, the camera system 100 may be connected to or integrated with a computing device, such as a laptop computer, a desktop computer, an all-in-one (AIO) computer, or the like, to be employed by real-time video conferencing applications, or the like.

The camera 106 may be any suitable optical imaging device which captures image and video data of an environment. In particular, the camera 106 has a primary field of view 114 within which the camera 106 captures image and video data.

The auxiliary sensors 108-1, 108-2 108-3, and 108-4 (referred to herein generically as an auxiliary sensor 108 and collectively as auxiliary sensors 108) are sensors capable of detecting objects, such as the target object 102. In particular, the auxiliary sensors 108 are to generate auxiliary sensor data representing respective auxiliary fields of view 116-1, 116-2, 116-3, and 116-4. For example, the auxiliary sensors 108 may be time-of-flight sensors, or other range finding sensors. Each auxiliary sensor 108 is to scan its respective auxiliary field of view 116 and generate auxiliary sensor data representing its respective field of view 116. For example, the auxiliary sensor data may indicate whether or not an object is detected within the respective auxiliary field of view 116.

The auxiliary fields of view 116 include at least a portion of the coverage area 104. In the present example, each auxiliary field of view 116 is a sector of the coverage area 104. That is, the auxiliary sensors 108 are centrally located, proximate the camera 106, facing radially outwards from the camera 106. Further, to maintain coverage of the given sector of the coverage area 104, the auxiliary sensors 108 are fixed within the camera system 100, and do not rotate with the camera 106, as described further herein. For example, if the coverage area 104 is about 180°, each of the four auxiliary sensors 108 may cover a sector of about 45° of the coverage area 104. In other examples, more or fewer auxiliary sensors 108 may be employed based on the range of the auxiliary fields of view 116 and/or based on the range of the coverage area 104. For example, if each auxiliary field of view 116 is about 30°, the camera system 100 may employ six auxiliary sensors 108 to cover a 180° coverage area, or twelve auxiliary sensors 108 to cover a 360° coverage area. In some examples, the auxiliary fields of view 116 may overlap to define smaller sectors of the coverage area 104.

The controller 110 may be a microcontroller, a microprocessor, a processing core, or similar device capable of executing instructions. The controller 110 may also include or be interconnected with a non-transitory machine-readable storage medium that may be electronic, magnetic, optical, or other physical storage device that stores executable instructions allowing the controller 110 to perform the functions described herein. In particular, the instructions may cause the controller 110 to obtain auxiliary sensor data from each of the auxiliary sensors 108, determine a location of the target object 102 within the coverage area 104, and control the motor 112 to rotate the camera 106 to locate the target object 102 within the primary field of view 114 of the camera 106.

The motor 112 is therefore connected to the camera 106 to rotate the camera 106 to move the primary field of view 114 of the camera 106 about the coverage area 104. In particular, the motor 112 may be to adjust at least a yaw angle of the camera 106. In some examples, the motor 112 may also adjust a pitch angle of the camera 106 and/or a roll angle of the camera 106.

In particular, the motor 112 may be a stepping motor, having specific, predefined yaw angles to which the motor 112 rotates the camera 106. The predefined yaw angles may be defined based on the sectors defined by the auxiliary sensors 108. For example, when the auxiliary sensors 108 have a 45° auxiliary fields of view 116, the auxiliary fields of view 116 may overlap with adjacent fields of view 116 by about 15°. Sectors of the coverage area may then be defined in 15° increments based on a first overlap sector of a given auxiliary sensor 108 with the closest counterclockwise-adjacent auxiliary sensor 108, a central sector of the given auxiliary sensor 108, and a second overlap sector of the given auxiliary sensor 108 with the closest clockwise-adjacent auxiliary sensor 108. Accordingly, in such examples, the predefined yaw angles may be at the respective centers of the first overlap sector, the central sector and the second overlap sector of each auxiliary sensor 108.

As will be appreciated, the coverage area 104 may be defined based on the physical constraints of the motor 112 and its capacity to adjust the yaw and pitch angles of the camera 106, as well as the extent of the primary field of view 114 of the camera 106 at the physical limits of the motor 112. For example, the camera system 100 may be integrated as a webcam of an all-in-one computing device, and hence the coverage area 104 may be limited to a 180° or less view facing outward from the all-in-one computing device. In other examples, the camera system 100 may be a webcam unit discrete from the computing device with which it is connected, and hence the coverage area may extend beyond a 180° view, for example, to a 360° view.

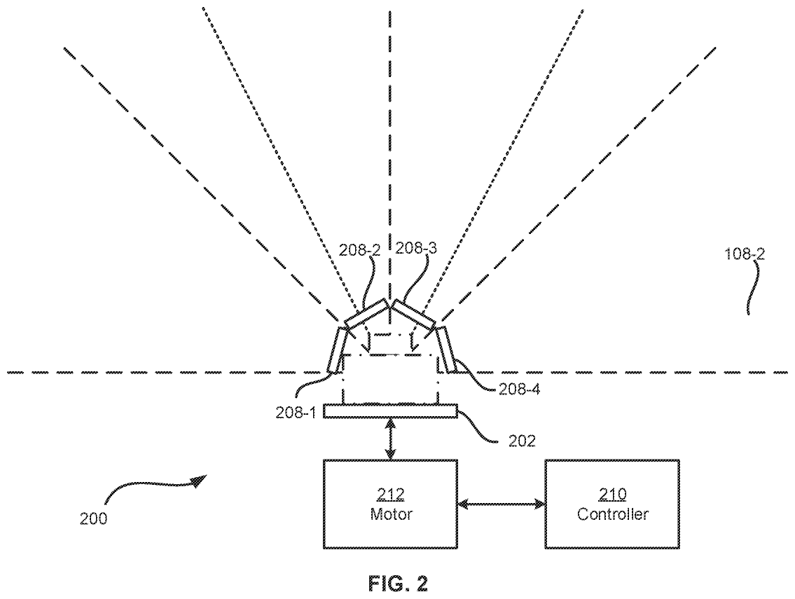

In still further examples, the tracking functionality may be implemented in a camera mount for a camera, independent of the camera itself. For example, referring to FIG. 2, an example camera mount 200 is depicted. The camera mount 200 is for a camera (shown in dashed lines) to allow the camera to track a target object. The camera mount 200 includes a holder 202 to hold the camera, a plurality of auxiliary sensors, of which four example auxiliary sensors 208-1, 208-2, 208-3, and 208-4 are depicted, a controller 210 and a motor 212.

The holder 202 is to hold the camera and may include suitable fixtures, such as detents, snaps, straps, fasteners, shoes, dovetails, or the like, to secure the camera to the holder 202. In particular, the holder 202 may be shaped to receive the camera in a particular orientation, such that a field of view of the camera is oriented in a predefined direction relative to the holder 202. This fixed configuration of the camera and the holder 202 allows the camera mount 200 to rotate the holder 202 and reliably predict the orientation of the field of view of the camera based on the orientation of the holder 202.

The auxiliary sensors 208, the controller 210, and the motor 212 are similar to the auxiliary sensors 108, controller 110, and motor 112, respectively. In particular, the auxiliary sensors 108 are to generate auxiliary sensor data representing respective auxiliary fields of view of the auxiliary sensors. The motor 212 is connected to the holder 202 to rotate the holder 202. The controller 210 is to obtain the auxiliary sensor data from each of the auxiliary sensors 208, determine, based on the auxiliary sensor data, a location of the target object, and control the motor 212 to adjust a yaw angle of the holder 202 to track the location of the target object.

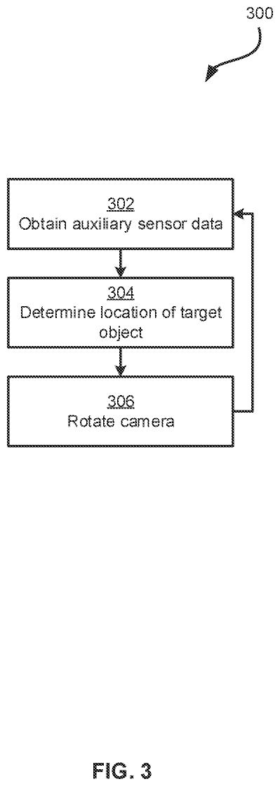

FIG. 3 depicts a flowchart of an example method 300 of tracking a target object. The method 300 will be described in conjunction with its performance in the camera system 100, and in particular by the controller 110. In other examples, the method 300 may be performed by other suitable devices or systems, such as the controller 210 of the camera mount 200.

At block 302, the controller 110 obtains auxiliary sensor data from each of the auxiliary sensors 108. The auxiliary sensor data represents the respective auxiliary field of view 116 of the corresponding auxiliary sensor 108. In particular, the auxiliary sensor data may include an indication of whether or not an object is detected in the auxiliary field of view 116, and, if at least one object is detected, a distance value for each object detected in the auxiliary field of view 116.

At block 304, the controller 110 determines, based on the auxiliary sensor data, a location of the target object 102 within the coverage area 104. For example, if multiple objects are detected, the controller 110 may identify a nearest object, a farthest object, or an object within a predefined distance range as the target object 102, in accordance with a predefined criteria. The predefined criteria may be selected, for example, based on user input, according to an expected use case for tracking the target object 102. For example, in the use case of a teacher teaching a class, the predefined criteria may be selected to be the farthest detected object, since the teacher may expect to be distant from the camera 106, and to reduce the likelihood of the camera system 100 tracking other intervening objects, such as a desk, another person or pet inadvertently crossing through the coverage area 104, or the like. The particular manner of determining the location of the target object 102 may be based on the set up of the auxiliary sensors 108 in the camera system 100, as will be described in further detail below. For example, the location of the target object 102 may be identified as a certain sector of the coverage area 104 of the camera system 100, or the location of the target object 102 may be determined relative to the primary field of view 114 of the camera 106.

At block 306, the controller 110 controls the motor 112 to rotate the camera 106 to locate the target object 102 within the primary field of view 114 of the camera 106. In particular, the motor 112 may adjust the yaw angle of the camera 106 to track the location of the target object 102. For example, when the location of the target object 102 is determined to be a given sector of the coverage area 104, the motor 112 may rotate the camera 106 such that the primary field of view 114 overlaps with the given sector identified as containing the target object 102. In other examples, when the location of the target object 102 is determined relative to the primary field of view 114 of the camera 106, the motor 112 may rotate the camera 106 in a clockwise or counter-clockwise direction, in accordance with the relationship of the location of the target object 102 to the primary field of view 114. In some examples, the controller 110 may additionally control the motor 112 to adjust the pitch of the camera 106. The controller 110 may then loop back to block 302 to obtain auxiliary sensor data to continue tracking the target object 102.

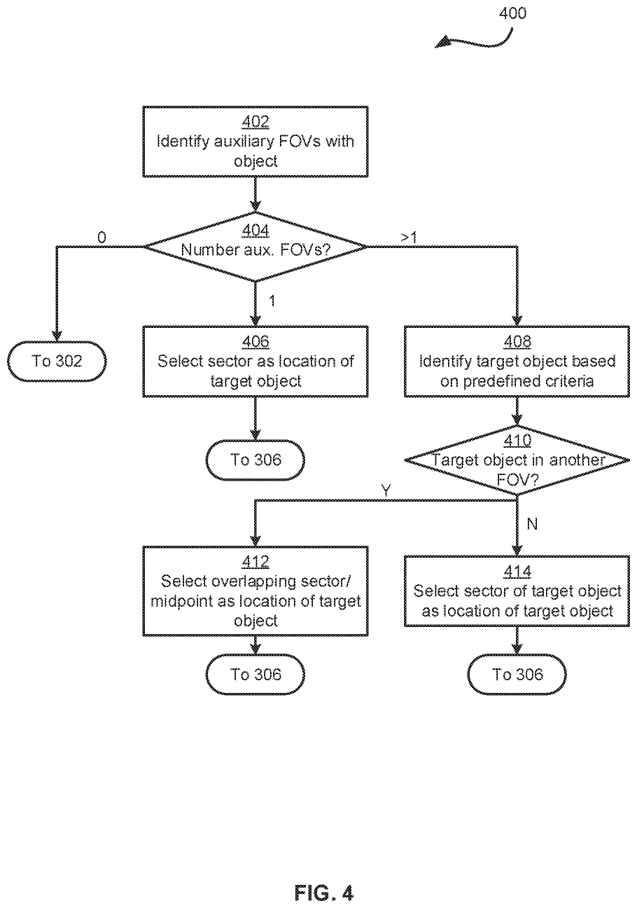

FIG. 4 depicts a flowchart of an example method 400 of determining the location of the target object 102 at block 304 of FIG. 3 within the coverage area 104. In particular, the method 400 is performed in a camera system having auxiliary sensors in the arrangement depicted in FIG. 1, in which each auxiliary sensor 108 has an auxiliary field of view 116 representing a sector of the coverage area 104.

At block 402, the controller 110 identifies auxiliary fields of view 116 having an object identified therein, for example, based directly on the auxiliary sensor data.

At block 404, the controller 110 determines how many auxiliary fields of view 116 have objects identified therein, and selects how to proceed based on the number of auxiliary fields of view 116 having detected objects.

If, at block 404, the controller 110 determines that no auxiliary fields of view 116 have an object identified therein, the controller 110 returns to block 302 of the method 300. That is, the controller 110 may control the auxiliary sensors 108 to continue scanning the respective fields of view 116 and obtain additional auxiliary sensor data to subsequently analyze.

If, at block 404, the controller 110 determines that exactly one auxiliary field of view 116 has an object identified therein, the controller 110 proceeds to block 406. At block 406, the controller 110 identifies the detected object as the target object 102 and selects the sector corresponding to the auxiliary field of view 116 as the location of target object 102. The controller 110 may then proceed to block 306 of the method 300 to rotate the camera 106 to track the location of the target object 102.

If, at block 404, the controller 110 determines that more than one auxiliary field of view 116 has an object identified therein, the controller 110 proceeds to block 408. At block 408, the controller 110 retrieves a predefined criteria for identifying the target object. For example, the predefined criteria may be the nearest object, the farthest object, an object within a predefined distance range, a nearest or farthest object within the predefined distance range, or the like. The predefined criteria may be defined by user input, based on the expected location of the target object 102 to be tracked. The controller 110 then identifies the object satisfying the predefined criteria as the target object 102, and selects auxiliary field of view 116 containing the target object 102 for further processing.

At block 410, the controller 110 determines whether the target object 102 is also detected in any other auxiliary fields of view 116. In particular, when the auxiliary fields of view 116 overlap, or when the target object 102 is on the border between auxiliary fields of view 116, the target object 102 may be detected in two adjacent auxiliary fields of view 116. Accordingly, the controller may determine whether any auxiliary fields of view 116 adjacent to the auxiliary field of view 116 selected at block 408 also contain an object at a distance within a threshold distance from the target object 102. That is, the controller 110 may determine whether the distance value of an object identified in an adjacent auxiliary field of view 116 is within a threshold percentage (e.g., 3%, 5%, 10%, or the like) of the distance value of the target object 102. In other examples, rather than a threshold percentage, an absolute distance value may be used, that is, that the distance value of an object identified in an adjacent auxiliary field of view 116 is within a threshold distance (e.g., 10 cm, 50 cm, or the like) of the distance value of the target object 102.

If the determination at block 410 is affirmative, that is, an object detected in an auxiliary field of view 116 adjacent to the selected auxiliary field of view 116 is within a threshold distance from the target object 102, the controller 110 proceeds to block 412. In particular, if the objects identified in adjacent auxiliary fields of view 116 are at similar distances, the controller 110 may determine that the same object is detected in both of the adjacent auxiliary fields of view 116. That is, the controller 110 may determine that the target object 102 is in an overlapping sector between the auxiliary field of view 116 selected at block 408 and the adjacent auxiliary field of view 116 identified at block 410, if the auxiliary fields of view 116 overlap, or at a midpoint between the auxiliary field of view 116 selected at block 408 and the adjacent auxiliary field of view 116 identified at block 410, if the auxiliary fields of view 116 do not overlap. Accordingly, at block 412, the controller 110 selects the overlapping sector and/or the midpoint between the auxiliary field of view 116 selected at block 408 and the adjacent auxiliary field of view 116 identified at block 410 as the location of the target object 102. The controller 110 may then proceed to block 306 of the method 300 to rotate the camera 106 to track the location of the target object 102.

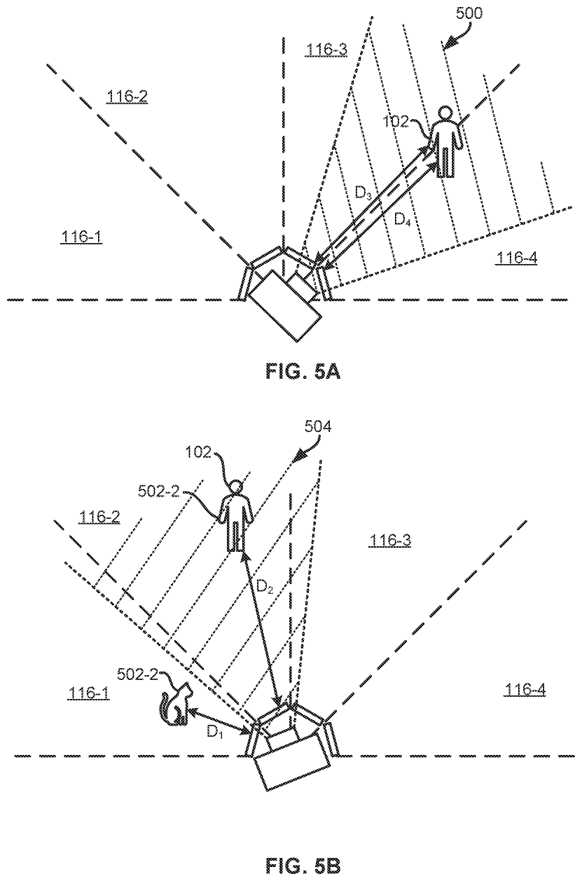

For example, referring to FIG. 5A, a schematic diagram of the identification of the location of the target object 102 in accordance with block 412 is depicted. As can be seen, the target object 102 is between auxiliary fields of view 116-3 and 116-4. Since the auxiliary sensors 108-3 and 108-4 are centrally located and face radially outwards, it can be expected that the distances D₃ and D₄ representing the determined distance from the auxiliary sensors 108-3 and 108-4 to the target object 102, respectively, are similar to one another. Accordingly, the controller 110 may define a sector 500 centered about a midpoint between the auxiliary fields of view 116-3 and 116-4 and select the sector 500 as the location of the target object 102.

Returning to FIG. 4, if the determination at block 410 is negative, that is, that no objects are detected in adjacent auxiliary fields of view 116, or that the objects detected in the adjacent auxiliary fields of view 116 are not within the threshold distance from the target object 102, the controller 110 proceeds to block 414. In particular, the controller 110 determines that any objects detected in adjacent auxiliary fields of view 116 are distinct from the target object 102. Accordingly, at block 414, the controller 110 selects the sector corresponding to the auxiliary field of view 116 selected at block 408 as the location of the target object 102. The controller 110 may then proceed to block 306 of the method 300 to rotate the camera 106 to track the location of the target object 102.

For example, referring to FIG. 5B, a schematic diagram of the identification of the location of the target object 102 in accordance with block 414 is depicted. In this example, there are two distinct objects, 502-1 and 502-2 which are located in the coverage area 104, and specifically, in auxiliary fields of view 116-1 and 116-2, respectively. The objects 502-1 and 502-2 are located distances at D₁ and D₂ from the auxiliary sensors 108-1 and 108-2, respectively. Based on the predefined criteria, the controller 110 may determine that D₂ is greater than D₁, and hence that the object 502-2 is the farthest object from the camera 106, and hence select the object 502-2 as the target object 102. Further, since the distances D₁ and D₂ are not similar to one another, the controller 110 determines that the object 502-1 detected in the first auxiliary field of view 116-1 is different from the object 502-2 detected in the second auxiliary field of view 116-2. Accordingly, the controller 110 determines that the second auxiliary field of view 116-2 is the only auxiliary field of view 116-2 containing the target object 102, and selects a sector 504 corresponding to the auxiliary field of view 116-2 as the location of the target object 102.

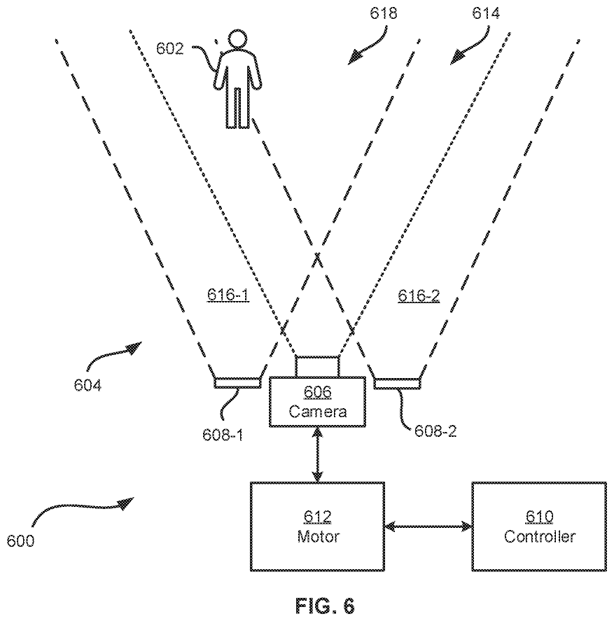

In other examples, other configurations of the auxiliary sensors in the camera system are contemplated. For example, referring to FIG. 6, another example camera system 600 is depicted. The camera system 600 is to track a target object 602 within a coverage area 604 and includes a camera 606, two auxiliary sensors 608-1 and 608-2, a controller 610, and a motor 612. The camera system 600 is similar to the camera system 100 with like components having like numbers.

In the camera system 600, the first auxiliary sensor 608-1 is laterally spaced in a first direction from the camera 606 and the second auxiliary sensor 608-2 is laterally spaced in a second direction, opposite the first direction, from the camera 606. A primary field of view 614 and auxiliary fields of view 616-1 and 616-2 are oriented in substantially the same direction. Accordingly, since each of the auxiliary fields of view 616 is generally conical in shape and hence has an increasing radius away from the auxiliary sensor 608, the first auxiliary field of view 616-1 and the second auxiliary field of view 616-2 overlap to define an overlapping portion 618. Further, the auxiliary sensors 608 and the camera 606 may be arranged such that the overlapping portion 618 is contained within the primary field of view 614. In particular, the auxiliary sensors 608 may be fixed relative to the camera 606 and rotate with the camera to maintain the spatial relationship of the primary field of view 614 with the auxiliary fields of view 616, and in particular, with the overlapping portion 618.

It will further be appreciated that the configuration of the auxiliary sensors 608 may also be implemented in the camera mount 200, rather than in the camera system 600 with the camera 606. The camera system 600 may similarly be used to track the target object 602 to maintain the target object 602 within frame of the camera 606, for example, by implementing the method 300. That is, the controller 610 may obtain auxiliary sensor data from each of the auxiliary sensors 608, determine, based on the auxiliary sensor data, a location of the target object 602 within the coverage area 604, and control the motor 612 to rotate the camera 606 to locate the target object 602 within the primary field of view 614 of the camera 606.

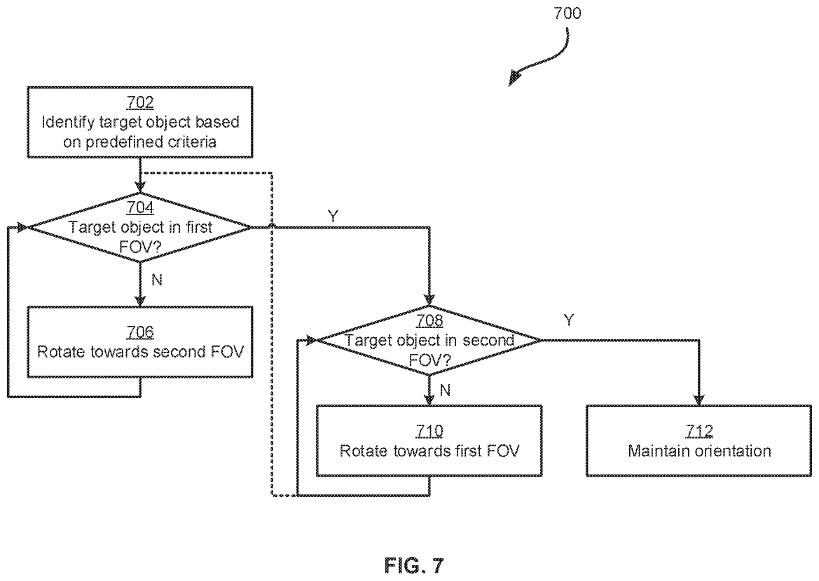

For example, referring to FIG. 7, a flowchart of an example method 700 of determining a location of the target object 602 at block 304 and controlling the motor 112 to rotate the camera 606 to locate the target object 602 within the primary field of view 614 of the camera 606 at block 306 of the method 300 is depicted. In particular, the method 700 is performed in a camera system having auxiliary sensors in the arrangement depicted in FIG. 6, in which two auxiliary sensors 608 laterally spaced from the camera 606, with an overlapping portion 618 of the auxiliary fields of view 616 contained in the primary field of view 616 of the camera 606.

At block 702, the controller 610 uses the auxiliary sensor data obtained at block 302 to identify the target object. In particular, the controller 610 may identify which of the two auxiliary fields of view 616 have objects identified therein. If more than one object is identified in the auxiliary fields of view 616, the controller 610 may retrieve the predefined criteria for identifying the target object 602. The controller 610 may then identify the object satisfying the predefined criteria as the target object 602. The controller 610 may also retrieve the distance value for the target object 602 from the auxiliary sensor data.

At block 704, the controller 610 determines whether the target object 602 is in the first auxiliary field of view 616-1. In particular, the controller 610 may check for an object in the first auxiliary field of view 616-1 which has a distance value within a threshold distance from the distance value of the target object 602. For example, the threshold distance may be expressed in terms of a threshold percentage or a threshold absolute distance. If such an object is detected in the first auxiliary field of view 616-1, then the controller 610 may determine that said object is the target object 602.

If, at block 704, the controller 610 determines that the target object 602 is not in the first auxiliary field of view 616-1, the controller 610 proceeds to block 706. At block 706, since the target object 602 is not in the first auxiliary field of view 616-1, the controller 610 may also therefore deduce that the target object 602 is in the second auxiliary field of view 616-2. Accordingly, the controller 610 controls the motor 612 to rotate the camera 606 towards the second auxiliary field of view 616-2. For example, in the present example, from the top view depicted, the motor 612 rotates the camera 606 in a clockwise direction. The controller 610 may then return to block 704 to determine whether the target object 602 is now detected in the first auxiliary field of view 616-1.

If, at block 704, the controller 610 determines that the target object 602 is detected in the first auxiliary field of view 616-1, the controller 610 proceeds to block 708. At block 708, the controller 610 determines whether the target object 602 is in the second auxiliary field of view 616-2. In particular, the controller 610 may check for an object in the second auxiliary field of view 616-2 which has a distance value within a threshold distance from the distance value of the target object 602. For example, the threshold distance may be expressed in terms of a threshold percentage or a threshold absolute distance. If such an object is detected in the second auxiliary field of view 616-2, then the controller 610 may determine that said object is the target object 602.

If, at block 708, the controller 610 determines that the target object 602 is not in the second auxiliary field of view 616-2, the controller 610 proceeds to block 710. At block 710, since the target object is in the first auxiliary field of view 616-1 but not the second auxiliary field of view 616-2, the controller 610 controls the motor 612 to rotate the camera 606 towards the first auxiliary field of view 616-1. For example, in the present example from the top view depicted, the motor 612 rotates the camera 606 in a counter-clockwise direction. The controller 610 may then return to block 708 to determine whether the target object 602 is now detected in the second auxiliary field of view 616-2. In some examples, rather than simply returning to block 708, the controller 610 may return to block 704 to confirm that the target object 602 is still within the first auxiliary field of view 616-1.

If, at block 708, the controller 610 determines that the target object 602 is detected in the second auxiliary field of view 616-2, the controller 610 proceeds to block 712. At block 712, the controller 610 may deduce that the target object 602 is in the overlapping portion 618, and therefore within the primary field of view 616 of the camera 606. Accordingly, the controller 610 may maintain the current orientation (i.e., the current yaw) of the camera 606.

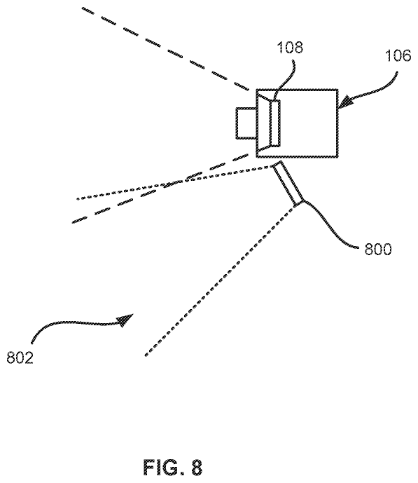

In some examples, addition to rotating the camera to change the yaw angle of the camera, the motor may additionally be to change the pitch of the camera. Referring to FIG. 8, a side view of the camera system 100 is depicted. In addition to the auxiliary sensors 108, which are spaced radially to detect objects at different yaw angles relative to the camera 106, the camera system 100 may additionally include a vertical auxiliary sensor 800. The vertical auxiliary sensor 800 is also a sensor capable of detecting objects, such as a time-of-flight sensor, or other range finding sensor.

The vertical auxiliary sensor 800 is vertically spaced and angled to cover a different pitch angle than the auxiliary sensors 108, to cover a vertical auxiliary field of view 802. Since a majority of the movement of the target object 102 may be expected to be captured by the auxiliary sensors 108, the camera system 100 may include a single vertical auxiliary sensor 800. Accordingly, the vertical auxiliary sensor 800 may be connected to the camera 106, and rotate with the camera 106 so that the yaw of the vertical auxiliary sensor 800 corresponds with the yaw of the camera 106.

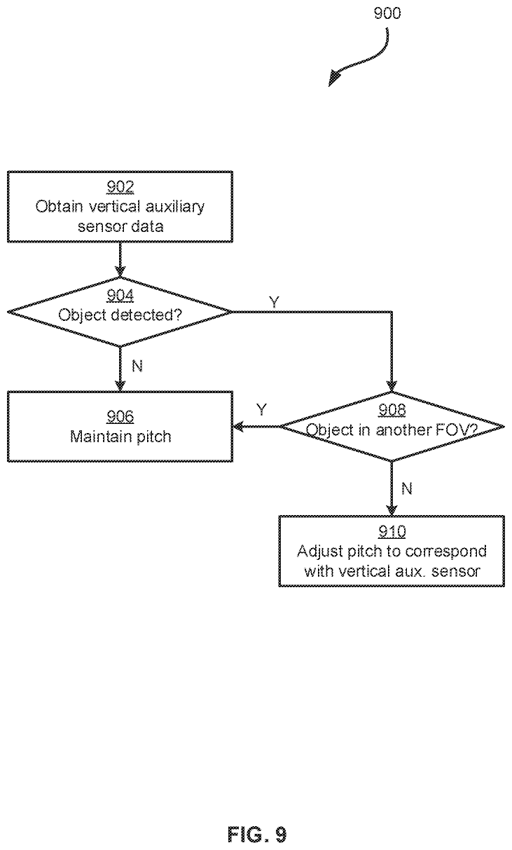

FIG. 9 depicts a flowchart of an example method 900 of adjusting the pitch of the camera 106, using the vertical auxiliary sensor 800.

At block 902, the controller 110 obtains vertical auxiliary sensor data from the vertical auxiliary sensor 800. The vertical auxiliary sensor data represents the vertical auxiliary field of view 802 and may include an indication of whether or not an object is detected in the vertical auxiliary field of view 802 and a distance value for any objects detected in the vertical auxiliary field of view 802.

At block 904, the controller 110 determines, based on the vertical auxiliary sensor data, whether the vertical auxiliary sensor 800 detects an object in the vertical auxiliary field of view 802.

If the determination at block 904 is negative, that is, that no object is detected in the vertical auxiliary field of view 802, the controller 110 proceeds to block 906 and maintains the pitch of the camera 106. In particular, the controller 110 may determine that the target object 102 is not in the vertical auxiliary field of view 802 and hence the pitch of the camera 106 does not need to be adjusted to maintain the target object 102 within the primary field of view 114.

If the determination at block 904 is affirmative, that is, that an object is detected in the vertical auxiliary field of view 802, the controller 110 proceeds to block 906. At block 908, the controller 110 retrieves updated auxiliary sensor data from the corresponding auxiliary sensor 108 at the same yaw angle as the vertical auxiliary sensor 800. That is, since the vertical auxiliary sensor 800 rotates with the camera 106 and has the same yaw angle as the camera 106, the auxiliary sensor data from the corresponding auxiliary sensor 108 together with the vertical auxiliary sensor data provide a representation of the objects at different pitches within the same yaw angle in front of the camera 106.

The controller 110 may then determine whether the auxiliary sensor(s) 108 at the same yaw angle as the vertical auxiliary sensor 800 detects an object. In particular, the controller 110 may determine whether the auxiliary sensor(s) 108 at the same yaw angle detects the same object identified in the vertical auxiliary sensor data. For example, this determination may be made based on the similarity between the distance values of the objects identified in the vertical auxiliary sensor data and the auxiliary sensor data from the auxiliary sensors 108.

If the controller 110 determines, at block 908 that the same object is detected by the auxiliary sensor(s) 108, the controller 110 proceeds to block 906 and maintains the pitch of the camera 106. In particular, the controller 110 may determine that the target object 102, while in the vertical auxiliary field of view 802, is also still in at least one of the auxiliary fields of view 116, and hence the pitch of the camera 106 does not need to be adjusted to maintain the target object 102 within the primary field of view 114.

If the controller 110 determines, at block 908 that the same object is not detected by the auxiliary sensor(s) 108, the controller 110 proceeds to block 910. At block 910, the controller 110 controls the motor 112 to adjust the pitch of the camera 106 to correspond with the pitch of the vertical auxiliary sensor 800. In particular, not having found the target object 102 within the auxiliary sensors 108, the controller 110 may determine that the target object 102 is now outside of the primary field of view 114. Since the camera 106 was tracking the location of the target object 102 in the coverage area 104, in accordance with the method 300, and an object is detected by the vertical auxiliary sensor 800, the controller 110 may therefore determine that the object in the vertical auxiliary field of view 802 is the target object 102 and adjust the pitch of the camera 106 to maintain the target object 102 within the primary field of view 114.

As described above, an example camera system can track objects moving within a coverage area for the camera system (e.g., a teacher walking back and forth in front of a blackboard) with simple, inexpensive auxiliary sensors, such as time-of-flight sensors, rather than employing expensive artificial intelligence or image processing solutions.

The scope of the claims should not be limited by the above examples, but should be given the broadest interpretation consistent with the description as a whole.

1. A camera system for tracking a target object within a coverage area, the camera system comprising:
a camera having a primary field of view;
a plurality of auxiliary sensors, each auxiliary sensor to generate auxiliary sensor data representing a respective auxiliary field of view of at least a portion of the coverage area;
a controller to:
obtain the auxiliary sensor data from each of the auxiliary sensors; and
determine, based on the auxiliary sensor data, a location of the target object within the coverage area; and
a motor connected to the camera to rotate the camera to locate the target object within the primary field of view.

2. The camera system of claim 1, wherein the auxiliary sensors comprise time-of-flight sensors.

3. The camera system of claim 1, wherein each auxiliary sensor is fixed such that the respective auxiliary field of view of each auxiliary sensor comprises a sector of the coverage area.

4. The camera system of claim 1, wherein the plurality of auxiliary sensors comprise:
a first auxiliary sensor laterally spaced from the camera in a first direction;
a second auxiliary sensor laterally spaced from the camera in a second direction opposite the first direction; and
wherein a first auxiliary field of view of the first auxiliary sensor and a second auxiliary field of view of the second auxiliary sensor overlap to define an overlapping portion, wherein the overlapping portion is contained within the primary field of view.

5. The camera system of claim 1, further comprising:
a vertical auxiliary sensor angled at a different pitch angle than the plurality of auxiliary sensors, the vertical auxiliary sensor to generate vertical auxiliary sensor data; and
wherein the controller is to control the motor to change a pitch of the camera based on the vertical auxiliary sensor data.

6. The camera system of claim 1, wherein the camera system is integrated as a webcam of a computing device.

7. A camera mount for a camera, the camera mount comprising:
a holder to hold the camera;
a plurality of auxiliary sensors, each auxiliary sensor to generate auxiliary sensor data representing a respective auxiliary field of view of the auxiliary sensor;
a motor to rotate the holder; and
a controller to:
obtain the auxiliary sensor data from each of the auxiliary sensors;
determine, based on the auxiliary sensor data, a location of a target object; and
control the motor to adjust a yaw angle of the holder to track the location of the target object.

8. The camera mount of claim 7, wherein the holder is to hold the camera such that a field of view of the camera is oriented in a predefined direction relative to the holder.

9. The camera mount of claim 7, wherein the respective auxiliary field of view of each auxiliary sensor comprises a sector of a coverage area for the camera mount.

10. A method of tracking a target object within a coverage area of a camera, the method comprising:
obtaining auxiliary sensor data from each of a plurality of auxiliary sensors;
determining, based on the auxiliary sensor data, a location of the target object within the coverage area; and
controlling a motor to rotate the camera to locate the target object within a field of view of the camera.

11. The method of claim 10, wherein determining the location of the target object comprises:
identifying, based on the auxiliary sensor data, sectors of the coverage area having an object identified therein; and
selecting one of the sectors as the location of the target object based on a predefined criteria for the location of the target object.

12. The method of claim 11, wherein selecting one of the sectors comprises:
when one auxiliary field of view has an object identified therein, selecting a sector corresponding to the auxiliary field of view as the location of the target object; and
when more than one auxiliary field of view has an object identified therein:
selecting one of the auxiliary fields of view based on the predefined criteria as having the target object;
determining whether the target object is also detected in an adjacent auxiliary field of view; and
when the target object is also detected in an adjacent auxiliary field of view, selecting a sector about a midpoint between the selected auxiliary field of view and the adjacent auxiliary field of view as the location of the target object; and
when the target object is not also detected in an adjacent auxiliary field of view, selecting the sector corresponding to the auxiliary field of view as the location of the target object.

13. The method of claim 11, wherein the predefined criteria comprises one of: a nearest object; and a farthest object.

14. The method of claim 10, wherein determining the location of the target object and controlling the motor comprises:
identifying the target object based on a predefined criteria for the target object;
if the target object is identified in a first auxiliary field of view of a first auxiliary sensor, and not in a second auxiliary field of view of view of a second auxiliary sensor, rotating the camera towards the first auxiliary field of view; and
if the target object is identified in the second auxiliary field of view and not the first auxiliary field of view, rotating the camera towards the second auxiliary field of view.

15. The method of claim 10, further comprising:
obtaining vertical auxiliary sensor data from a vertical auxiliary sensor; and
when an object is detected by the vertical auxiliary sensor and not by the auxiliary sensors, controlling the motor to change a pitch of the camera.
